(19) United States
(12) Patent Application Publication
(10) Pub. No.: US 2011/0225800 A1
(43) Pub. Date: Sep. 22, 2011

(54) APPARATUS AND METHODS FOR INSERTING A FASTENER

(75) Inventors: Darren William Lacy, Victoria (AU); Christopher John Lacy, Diggers Rest, Victoria (AU)

(73) Assignee: Christopher John Lacy, Diggers Rest, Victoria (AU)

(21) Appl. No.: 13/129,530

(22) PCT Filed: Nov. 17, 2009
(86) PCT No.: PCT/AU2009/001487

§ 371 Date: May 16, 2011

Related U.S. Application Data
(60) Provisional application No. 61/202,216, filed on Feb. 6, 2009.

(30) Foreign Application Priority Data
Nov. 17, 2008 (AU) 2008905942

(51) Int. Cl. B23P 11/00; B25C 3/00

(52) U.S. Cl. 29/525.01; 81/44; 29/428

(57) ABSTRACT

The present invention provides a device for the insertion of fasteners into the ground for the purpose of anchoring sheet-like materials such as geotechnical mats in soil stabilization or for securing forms of netting to prevent crop wastage. A further aspect of this invention provides a form of securing fasteners by a method that reduces damage or impediment in the operation of the fastener insertion device.

### FIELD OF THE INVENTION

This invention relates generally to a device for the insertion of fasteners into the ground for the purpose of anchoring sheet-like materials such as geotechnical mats in soil stabilization or agricultural netting for the protection of crops.

### BACKGROUND TO THE INVENTION

Soil erosion can be a serious problem resulting in damage to water sources, landscaping, and wildlife. During construction works of residential and commercial infrastructure projects, vegetation, which protects soil from erosion, is often removed. Exposure of soils to the erosive forces of wind and rain can carry soil, sediment, organic matter and nutrients into stormwater. Soil erosion and sedimentation can be considered as one of the largest pollutants by volume in stormwater and generally in water run-off. It is therefore widely recognised that the control and prevention of soil erosion will aid in providing an improvement in general water quality and limit the impact on aquatic fauna and flora in receiving waterways.

Similarly, the revegetation of natural ecosystems and the control of weeds or other unwanted flora are of growing concern for many individuals. Weeds can often compete with productive crops or pasture, can be harmful to domesticated plants and livestock, and can convert productive land into unusable scrub. The use of chemical treatments or herbicides while often effective, has also been recognised as potentially damaging to a fragile soil systems or be otherwise harmful to those exposed during application. Aside from risks of exposure at the site of application, other factors such as pesticide drift or water pollution can occur upon employment of pesticide treatments whereby surrounding areas other than the target area can invariably be contaminated.

It is recognised that the repair of damage caused by soil erosion and weed management is not only difficult, but time consuming. The use of blankets or matting for purposes of either erosion control or the management of regeneration areas has been proposed as a potential solution to these problems. These systems may be highly effective when compared to other forms of management such as mulch in reducing run-off during rain events. Such mats or blankets, generally constructed from biodegradable substances such as straw, coconut, or wood fibre are placed onto prepared soils and areas to prevent them washing away.

Netting and similar barriers are often used to exclude birds and other animals from food crops. These physical barriers provide significant advantages to farmers or viticulturists by improving yields of viable and marketable crops. The installation of bird netting is generally accomplished by stretching out the net over the desired crop. To ensure complete coverage, the netting is typically anchored to the ground by a weighted object or latched the ground by a tie or fastener.

The installation of matting and netting as described supra, is time consuming and laborious. Typically, the method for anchoring matting is by insertion of fasteners through the matting into the underlying soil. Such fasteners can take the form of nails, pins, staples, U-shaped wires, stakes, or other similar objects of similar with operation. While the insertion of fasteners is often the most direct method for matting securement, it is a labour intensive process whereby each fastener is introduced by hand or in combination with a hammer depending on the hardness of the underlying topsoil.

The fastener is usually held in one hand and the hammer in the other and hit through the mat to embed into the soil or sand. As installation of erosion control blankets often occurs on sloped or inclined areas, it will often ensue that installing fasteners by hand can cause excessive strain to the operators, such as injury to their back, joints or muscles, or other regions of their body due to the repetitive nature of the operation. This is especially evident when the topology of the underlying ground is uneven, at an incline, or when the underlying soil is considerably hard.

It is recognised that portable and semi-portable hand-operable devices exist in the art for the insertion of fasteners for the securing of mats and netting to the ground. Fastener “punching” devices have been designed and built to replace the traditional practice of installing pins or staples with a hand held hammer. These devices aid in automating the insertion of fasteners by pushing the fasteners into the ground upon actuation of a shaft, piston or similar structure that makes contact with the fastener. While such devices provide an advantage over inserting the fasteners manually with a hammer, by allowing the installer to stand upright, and push on a spring loaded pole handle, these devices are typically heavy. Consequently, the operator is often burdened with carrying the device over long distances in the course of anchoring large areas of netting or matting. This can lead to significant occupational health and safety issues given the probability of back dysfunction and pain. This is exacerbated where the device is used in conditions where the operator must support the weight of the device on uneven and/or sloping grounds.

The weight of prior art devices thus significantly hampers the speed and efficiency with which geotechnical matting can be anchored. It is an aspect of the present invention to provide a device that overcomes or alleviates a problem of the prior art by providing a device having improved properties.

A further problem with devices of the prior art is that fastener devices often become unusable due to blockage by the fasteners. Where this occurs, the operator must attempt to withdraw the blocked fastener from the device before continuing work. It may even be necessary for the operator to at least partially dismantle the device in order to extract the fastener. This problem further compounds the effort involved in and efficiency of installing netting and matting.

An additional problem with devices of the prior art occurs upon torsional or angular vibration during movement of the shaft travelling along a fixed or semi-fixed axis. In these situations the fastener pusher or other fixtures attached to the shaft move within an undesired range of motion and further causes damage to the device due to abrasive and frictional forces. This problem can cause further damage and wear to fastener insertion devices in the art.

It is an aspect of the present invention to overcome or alleviate a problem of the prior art by providing a lighter weight device for the insertion of fasteners into ground. A further aspect of the invention provides a magazine of fasteners that is less likely to lead to blockage of these devices.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### BRIEF DESCRIPTION OF THE DRAWINGS

FIG. 1 shows a side elevation view of an embodiment of the present invention, a fastener insertion device represented in its open retracted position.

FIG. 2 is a cross-sectional internal view of one embodiment of the present invention, showing the relative locality of features comprising the fastener insertion interface.

FIG. 3 shows a side elevation of an embodiment of the present invention.

### SUMMARY OF THE INVENTION

Where the terms “comprise”, “comprises”, “comprised” or “comprising” are used in this specification (including the claims) they are to be interpreted as specifying the presence of the stated features, integers, steps or components, but not precluding the presence of one or more other features, integers, steps or components, or group thereof.

In a first aspect the present invention provides a hand-operable device for inserting a fastener into a substrate, the device comprising: fastener holding means; fastener guiding means coupled to the fastener holding means, fastener pushing means adapted to push the fastener from the faster holding means along the guiding means and toward the substrate, lining means disposed between the fastener guiding means and the fastener pushing means, wherein the lining means is composed of a material that is more prone to wear than the material of the pushing means such that in operation the lining means wears in preference to the guiding means and or pushing means. Applicant has discovered that significant improvements in the weight of such devices is achievable by the use light-weight materials in combination with the use of a sacrificial liner between the fastener guide and the shaft configured to contact and push the fastener into the substrate.

The guiding means may be any structure that acts to direct the fastener along a predetermined path during insertion of the fastener into the substrate. The guiding means may be a dedicated part of the device, or may simply be a part of a housing or cover. It is the guiding means that is subject to wear against the pushing means, given that the pushing means is typically in contact with the guiding means.

In one embodiment of the device, the guiding means is composed of a material lighter than iron or steel. These materials are used extensively in the devices of the prior art and are responsible to a large part for the excessive weights of existing devices. In one form, the guiding means is composed of a metal such as aluminium, or an aluminium alloy selected from the group consisting of duralumin, magnox and silumin; or comprising an alloy of aluminium comprising a metal selected from the group consisting of copper, zinc, manganese, silicon or magnesium.

In another form of the device, the guiding means is composed of a material of such as a heavy duty plastic, synthetic resin, or other suitable synthetic material of sufficient durability, but still lighter than iron or steel.

The use of a lining means allows for the incorporation of such light weight materials in the device. Lighter metals such as aluminium and aluminium alloys are typically soft, and therefore prone to wear. Accordingly, a device having surfaces composed of softer metals that contact and move past each other during operation of the device will rapidly fail due shearing forces acting to erode one or both of the surfaces. This is not a significant problem of prior art devices whereby the surfaces are composed of harder metals such as iron or steel. Applicant proposes that the use of lighter weight metals in combination with one or more sacrificial liners provides for a light weight device with greatly improved longevity and serviceability. When worn, the sacrificial liner can be easily replaced even by the operator in the field.

The lining means may be composed of a material such as brass, bronze, copper, carbon steel, spring steel, stainless steel, inconel, monel, nickel, tin and titanium. The choice of material will be dictated at least in part by the composition of the guiding means. As discussed supra the liner is composed of a material that is softer than that of the guiding means, such that the liner (being sacrificial) wears in preference to the guide. In one particular embodiment of the device, where the pushing means is composed of aluminium the sacrificial liner is composed of brass. In operation, movement of the aluminium pushing means against the softer brass liner leads to wearing of the sacrificial liner. In another embodiment of the device, the lining means selected may be lighter than the guiding means but also composed of a harder substance than the guiding means, such that the guiding means or pushing means may wear preferentially to the lining means. In yet another embodiment of the device, the lining means may be disposed of and the guiding means can be composed entirely of a material that is lighter than iron or steel.

In a further embodiment of the invention, the lining means may be composed of a material being substantially or completely synthetic and be selected based on its capacity to deteriorate or limit the deterioration of the material selected for the guiding or pushing means. Such materials for the synthetic lining means may be selected from any one of, but not limited to, nylon, teflon, rubber, cork, high molecular weight polyethylene or be a plastic or plastic composite or any other synthetic polymers or polyamides or thermoplastic fibre that possess abrasion resistance properties.

The lining means may be of any thickness or size provided that it is capable of providing protection to the guiding means or the pushing means from deterioration during operation. In one form of the device, the lining means has a thickness of less than approximately 0.025 mm. In a further form of the present invention, the lining means can of a range of thicknesses from approximately 1 mm to approximately 0.025 mm.

In one form of the invention, the lining means is comprised of separate units, of which one unit is shaped to form a complementary surface of the sliding hammer body, and the second unit to form a surface complementary to a cover plate. Typically, the cover plate present adjoining the sliding hammer body and is generally the outer covering plate of the hammer body. In a further form of the invention, the lining means is formed by many individual liners that are assembled to fit all available surfaces in the internal cavity of the sliding hammer body and occupying the available space around the fastener pusher. In yet another form of the invention, the lining means is a fully flexible membrane that conforms upon application of force to fill the internal space of the cavity between the sliding hammer body, the fastener pusher and the cover plate. In yet another form of the invention, any one of the lining means is secured to the internal surface of the sliding hammer body by an adhesive.

Applicant has discovered that problems in the prior art relating to internal damage caused by torsional or angular vibration of the shaft travelling along a fixed or semi-fixed axis can be significantly reduced. Applicant has determined that an undesired range of motion of the fastener pusher or other interconnected components can be restricted by introduction of bearings or additional guiding mechanisms attached to the pushing means or handle shaft. Applicant has determined that the application of bearings improves guidance of the pushing means and limits torsional movement of the pushing means along fixed or semi-fixed axis. The pushing means may be composed of any of the materials discussed supra. In one embodiment the pushing means is connected to the handle shaft such that the pushing means operates in movement with the handle shaft.

In one form of the invention, connected to the pushing means is one or more bearings aligned to the internal wall of the sliding hammer body, wherein the bearings are capable of making contact with the internal walls of the sliding hammer body. In another form of the invention, two or more bearings are connected to the pushing mean, however said bearing are mounted in an off-set manner so to provide restricted torsional movement of the pushing means and hammer shaft.

In a further embodiment, the present invention is a hand-operable device for inserting a fastener into a substrate, the device comprising: fastener holding means; fastener guiding means coupled to the fastener holding means, fastener pushing means adapted to push the fastener from the faster holding means along the guiding means and toward the substrate, the pushing or guiding means being fitted with a bearing or roller such that in use where the bearing or roller is fitted to the pushing means the bearing or roller contacts the guiding means, or where the bearing or roller is fitted to the guiding means the bearing or roller contacts the pushing means.

The present devices are of a significantly lighter weight than devices of the prior art having the same or similar capability. For example, some prior art devices weigh at least approximately 9.5 kilograms, and may weigh up to approximately 11 kilograms. By contrast, use of the materials described herein allows for the production of devices having a weight less than approximately 5.2 kilograms and even as low as approximately 4.5 kilograms

The device may include any or all of the features that are present in similar prior art devices. Such devices are described in U.S. Pat. No. 6,926,186. For example, the fastener pushing means may be part of an elongated handle secured in a shaft to a main body that at the base is attached to a means capable of pushing a fastener. The shaft and handle may be configured to push a fastener from the fastener holding means, along the guiding means and into a substrate. The handle may be secured in a shaft which possesses an internal mechanism to return to handle to the original retracted position (such as a spring), wherein a fastener guiding means is coupled to the fastener holding means and a fastener pushing means is connected to the elongated handle.

A further aspect of the present invention provides a magazine of fasteners, wherein the individual fasteners are maintained en bloc using a glue and/or a gum and/or paper and/or a tape. The Applicant has discovered that fasteners in the art collated or held together in close proximity by welding to a wire often cause fastener insertion devices to block either due to dislodgment of the wire in the internal of the fastener pusher, or as a result of the wire welding distorting the orientation of the fasteners. This damage often requires repair, unexpected downtime, delays, and often produces irreparable damage to the fastener insertion devices in the art. Applicant has discovered that collation of fasteners using paper and/or tape in combination with a gum and/or glue provides improvement compared to the fastener magazines in the art whereby the problems of jamming or causing damage to the fastener insertions devices is abrogated.

In one form of the invention, the composition of the glue is a spray adhesive with a high level of solids (approximately 10%-30% w/w) that is formulated to be highly heat resistant up to temperatures in excess of 50° C., and is capable of forming bonds on metals, heavy papers, wood and most plastics. In one embodiment of the invention, the glue selected to maintain the fasteners en bloc is the industrial grade spray adhesive 3M Scotch-Weld™ Hi-Strength Spray Adhesive 98NF. In yet another form of the invention, a suitable adhesive is combined with a kraft paper such that the paper and adhesive combine and when applied to the fasteners, secure the fasteners and provide limited movement when en bloc. In a further form of the invention, the kraft paper used is approximately 30 g/m². In yet another form of the invention, the kraft paper used can be selected from any number of kraft papers ranging from 30 g/m² to 100 g/m².

The Applicant has discovered that selecting a suitable combination of adhesive and paper ensures that the action of separating the fastener from the magazine of fasteners by the fastener pusher does not cause blockage or interference inside the fastener insertion device. Under elevated working temperatures the applicant has observed that an adhesive that is not of high heat tolerance invariable becomes more viscous and looses bonding. Such effects of adhesive failure result in the paper being loosing bonding to the fastener and therefore the paper becomes trapped in the sliding hammer body after the fastener is ejected from the fastener magazine by action of the fastener pusher. The Applicant has considered that the adhesive be suitably chosen to ensure that adequate bonding is constantly provided between the adhesive, paper or tape, and the fasteners such that the fastener insertion device can be operated in temperatures between 35° C. and 45° C. degrees without detriment to the securement of the fasteners en bloc.

The fasteners may be of any shape or composition so far as they are suitable for the desired used. In one form of the invention, the fasteners are substantially staple-shaped, and composed of a metal such as mild or high tensile steel. In another form of the invention, the fasteners can have a length of at least approximately 50 mm or at least approximately 100 mm or at least approximately 150 mm or at least approximately 200 mm.

In an alternative form of the present invention, the fasteners may be substantially shaped to form a stake or be substantially ‘T’ shaped, Such stakes or ‘T’ shaped fasteners can be similarly maintained or collated en bloc using wire, a glue, a gum, a tape.

In a further form of the present invention, the fasteners may take the shape of any of the previous embodiments but be composed of a material that is not metal. In such a form, the fasteners may be composed of a resin or of high density polymer such as a plastic. In another additional form, the material selected for the fasteners may be chosen based on the available biodegradable characteristics of the material, such that if a biodegradable matting or blanket is it to be utilised a similarly biodegradable fastener of similar biodegradable properties can used.

In a further aspect the present invention provides a kit of parts comprising a device as described herein and a magazine of fasteners as described herein. The kit optionally includes other articles such as matting, and/or instructions for use.

As discussed, the liner is designed to be sacrificial in nature and is therefore a replaceable part. Accordingly, a further aspect of the present invention provides a liner suitable for use in a device as described herein. The liner may be supplied alone, or in combination with instructions for fitting the liner to the device. The liner may take the form of one or several parts, however in one embodiment the liner is of unitary construction.

Yet a further aspect provides a method of inserting a fastener into a substrate, the method comprising use of a device, and/or a magazine of fasteners and/or a kit as described herein. In one embodiment of the method, the method comprises the steps of inserting a magazine of fasteners as described herein into a device as described herein; and actuating the fastener pushing means such that a fastener is inserted into the substrate.

These and other objects of and advantages of the present invention will no doubt become more apparent upon a reading of the following descriptions and a study of the figures of the drawing.

### DETAILED DESCRIPTION OF THE PREFERRED EMBODIMENT(S)

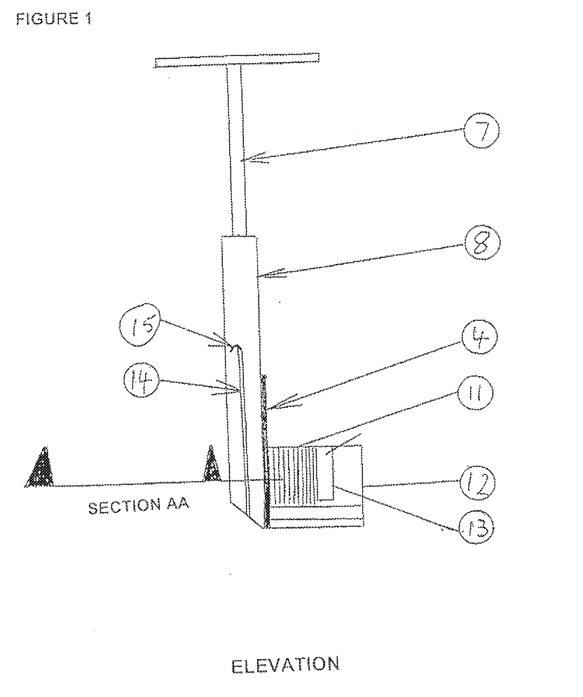

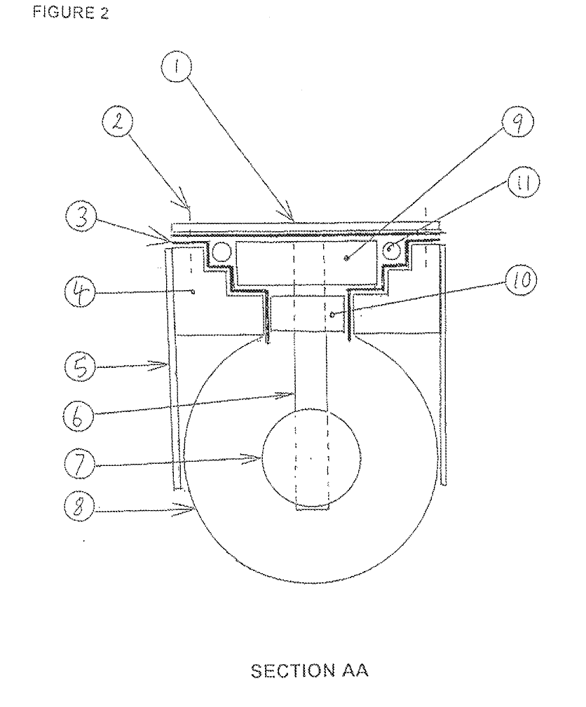

Referring to FIGS. 1 and 2, in one embodiment an assembled fastener insertion device is shown in FIG. 1. that includes either a hinged, or spring-loaded or detachable carriage 12 attached to a main body 8 comprising a reciprocating shaft with handle 7 configured to move relative to the detachable carriage 12. The interface between either hinged, or spring-loaded or the detachable carriage 12 and the main body 8 comprises a sliding hammer body 4 which is configured to house a sliding hammer 9 and hammer handle pin bearing 10. The fastener insertion device is configured to accommodate interchangeable fastener magazines or a single fastener in the detachable carriage 12. Each fastener is configured such that the fastener is fed inside the detachable carriage to the sliding hammer 9 such that the fastener 11 is driven out of the fastener insertion device and into the ground or other surface. It can be considered that such use might be to insert the fastener into the ground, and thereby affixing an object to the ground to limit the movement of the object. Such an object may be a blanket for the purposes of erosion control or weed-matting for selective re-vegetation purposes.

In one embodiment, the sliding hammer body 4 of the fastener insertion device FIG. 1 is contained within the main body 8, where the sliding hammer body 4 comprises a cover plate 1 secured to the sliding hammer body 4 by screws 2. The sliding hammer body 4 is enclosed by joining plates 5 located relative to the main handle shaft 7.

A sliding hammer body 4 housing a sliding hammer 9 is connected axially to the drive shaft trough a hammer handle pin 6 and a hammer handle pin bearing 10, with said drive shaft being reciprocable and interconnected to the sliding hammer 9 inside the sliding hammer body 4.

Proximally located at the interface of the sliding hammer 9 and the sliding hammer body 4 is a liner 3 of a material of substantial difference to the material used for the sliding hammer body 4 and/or the sliding hammer (fastener pusher) 9. The liner 3 can either be permanent or sacrificial and by its presence at interface limits wear or deterioration of the sliding hammer body 4 and or the sliding hammer 9 or fastener pusher 9 when in use.

In one embodiment, the liner 3 may be fitted to the device by removal of the detachable carriage 12 through the removal of screws that secure the detachable carriage to the hammer body 4. The liner 3 may be introduced to the fastener insertion device by removal of the detachable carriage 12 from the cover plate 1 by the removal of screws 2 located at positions to secure the cover plate 1 to the sliding hammer body 4. Once the screws 2 have been removed, the detachable carriage 12 can been separated from the sliding hammer body 4. Upon wearing of the liner 3 due to continued operation of the sliding hammer (fastener pusher) 9 operating to insert fasteners 11 in combination with the action of the handle shaft 7 interfacing with sliding hammer body 4, the liner 3 can be replaced with a new liner 3. After fitting of a new liner 3, the detachable carriage 12 can be reattached to the sliding hammer body 4 and secured with screws 2 that travel into the sliding hammer body 4.

In one form of the invention, the liner 3 may be composed of several parts and fitted to the device by removal of the detachable carriage 12 by removal of screws 2 to the cover plate 1. The liner 3 may be fitted to groves or indentations formed to receive the liner such that a close marriage of individual parts occurs between the liner, the sliding hammer body and the detachable carriage.

Magazines of fasteners or single fasteners operate in substantially the following matter by being aligned and top loaded into the detachable carriage 12 by first pivoting, retracting or removing a top door and retracting a spring loaded sliding block 13, inserting the fastener or fasteners into the carriage cavity, and replacing the pivoting or removable top door and returning the sliding block 13 to its original position. The action of the sliding block 13 inside the detachable carriage and in combination with the guiding means thereby provides that the fastener or fasteners are positioned to be in contact with the fastener pushing device and in close proximity to the sliding hammer body 4. It should be understood however that varying sizes of fasteners can by accommodated with only minimal revision of the carriage needed to mount them.

In another embodiment, magazines of fasteners or a single fastener may be loaded into the detachable carriage 12 by first retracting the spring loaded sliding block 13 via a spring loaded handle 15, the spring being in a protective housing 14. The movement of the spring loaded sliding block 13 is then controllable via the spring loaded handle 15. Following release of tension from the spring loaded handle 15 and the spring contained within the spring housing 14, the spring loaded block 13 can be retracted and a fastener or fasteners can be inserted into the detachable carriage 12. Reapplication of tension to the spring loaded handle 15 and spring present in the spring housing 14 provides retraction of the spring loaded sliding block 13 and provides that the fastener or fasteners are positioned to be in contact with the fastener pushier 9 and in close proximity to the sliding hammer body 4.

During operation, an operator transfers some of their body weight to the handle shaft 7, thereby causing the shaft of the handle shaft 7 to move downwardly toward the detachable carriage 12. The handle shaft 7 causes the shaft to move relative to the sliding hammer body 4, and thereby move the hammer handle pin 6 and sliding hammer 9 relative to the detachable carriage 12. As the sliding hammer (fastener pusher) 9 moves downwardly, it engages a fastener 11 and forces it out in a direction along the same downward axis as of which the handle 7 is travelling and into the ground. In one embodiment, the handle shaft 7 is attached to a spring handle such that when the operator's weight is removed or withdrawn from the handle shaft 7, an internal spring mechanism causes the handle shaft 7 and the likewise sliding hammer (fastener pusher) 9 to return to their retracted positions, at which point the process may be repeated again.

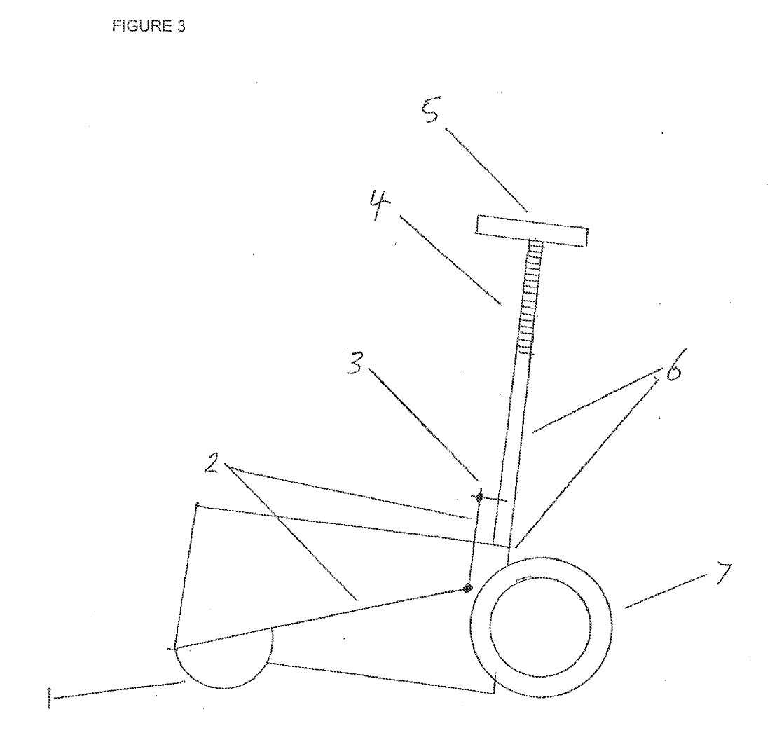

Referring to FIG. 3, the fastener is positioned at the bottom of the pole 4 and pushed into place from a spring loaded magazine. The pin is guided into the ground by the frame 6, the pole 4 and handle 5 act as a slow motion hammer, with the force being applied from the upper body through both arms. To support the pin frame 6, a pair of wheels 7, on an axel is mounted to the front, this supports the weight and more specifically allows for the units mobility, over all surface conditions.

This embodiment of the invention includes a locking pin 3, which locks the handle 5 into a fixed position when the device is not in contact with the ground. The locking pin 3, is connected to a skid plate 1, this skid plate 1, is on a pivot and is connected to the locking pin 3, through linkages 2, which engage and disengage the locking pin 3. This and other embodiments of the invention may be designed to install the spring pin 8, which is inserted into the ground while parallel and springs itself apart once in the ground. When the device is nearly in the ready position the skid plate 3, which releases the locking pin 3, is the first piece of the body to tough the ground, releasing the lock pin 3, and allowing the operator to push the handle 5 down. The action in reverse has the skid plate 1, leaving the ground last and engaging the lock pin 3, and locking the handle 5. This allows the Pin Puncher to be wheeled around freely (pushed or pulled) without the handle 5 engaging the next pin.

As distinct from the aforementioned manual system, an automatic system is further contemplated. This embodiment may be air operated whereby the spring on the handle is removed, the handle fixed, and an air ram is attached to act as the hammer which hits the fastener.

The air ram may have a hand and foot safety trigger, with both being engaged at the same time for the air ram to operate. When operated the ram will shoot a pin into the surface below.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as broadly described herein.

1. A hand-operable device for inserting a fastener into a substrate, the device comprising: fastener holding means; fastener guiding means coupled to the fastener holding means, fastener pushing means adapted to push the fastener from the faster holding means along the guiding means and toward the substrate, lining means disposed between the fastener guiding means and the fastener pushing means, wherein the lining means is composed of a material that is more prone to wear than the material of the pushing means such that in operation the lining means wears in preference to the guiding and or pushing means.

2. A device as according to claim 1 wherein the guiding means is composed of a material lighter than iron or steel.

3. A device according to claim 1 wherein the guiding means is composed of a metal.

4. A device according to claim 1 wherein the guiding means is composed of aluminium, or an aluminium alloy selected from the group consisting of duralumin, magnox and silumin; or comprising an alloy of aluminium comprising a metal selected from the group consisting of copper, zinc, manganese, silicon or magnesium.

5. A device according to claim 1 wherein the lining means is composed of a material selected from the group consisting of brass, bronze, copper, carbon steel, spring steel, stainless steel, inconel, monel, nickel, tin and titanium.

6. A device according to claim 1 wherein the lining means is composed of a material selected from the group consisting of either nylon, teflon, rubber, cork, high molecular weight polyethylene or where the liner is composed of either a plastic or a plastic composite or any other synthetic polymer or polyamide or thermoplastic fibre that possess abrasion resistance properties.

7. A hand-operable device for inserting a fastener into a substrate, the device comprising: fastener holding means; fastener guiding means coupled to the fastener holding means, fastener pushing means adapted to push the fastener from the faster holding means along the guiding means and toward the substrate, the pushing or guiding means being fitted with a bearing or roller such that in use where the bearing or roller is fitted to the pushing means the bearing or roller contacts the guiding means, or where the bearing or roller is fitted to the guiding means the bearing or roller contacts the pushing means.

8. A device according to claim 1 having a weight of less than approximately 9.5 kilograms.

9. A magazine of fasteners, wherein the individual fasteners are maintained en bloc using a glue and/or a gum and/or a tape.

10. A magazine of fasteners, wherein the fasteners have a length of at least of at least approximately 50 mm or at least approximately 100 mm or at least approximately 150 mm or at least approximately 200 mm.

11. A magazine according to claim 9 wherein the fasteners are substantially staple-shaped or are substantially T-shaped.

12. A magazine according to claim 9, wherein the fasteners are composed of a metal or of a high-density polymer.

13. A method for manufacturing a magazine of fasteners, the method comprising the steps of providing a plurality of fasteners, positioning the fasteners to form a magazine, applying a glue and/or a gum, and/or a tape to the fasteners to secure the fasteners en bloc.

14. A method according to claim 13 wherein the fasteners have a length of at least approximately 50 mm or at least approximately 100 mm or at least approximately 150 mm or at least approximately 200 mm.

15. A method for manufacturing a magazine of fasteners, the method comprising the steps of providing a plurality of fasteners, positioning the fasteners to form a magazine, applying a glue and/or a gum, and/or a tape to the fasteners to secure the fasteners en bloc;
wherein the magazine of fasteners are adapted for use in a fastener insertion device of claim 1.

16. A kit of parts comprising a device according to claim 1 and a magazine of fasteners, wherein the individual fasteners are maintained en bloc using a glue and/or a gum and/or a tape.

17. A liner suitable for use in a device according to claim 1.

18. A method of inserting a fastener into a substrate, the method comprising use of a kit according to claim 16.

19. A method of inserting a fastener into a substrate, the method comprising the steps: inserting a magazine of fasteners according to claim 9, into a hand-operable device for inserting a fastener into a substrate, the device comprising: fastener holding means; fastener guiding means coupled to the fastener holding means, fastener pushing means adapted to push the fastener from the faster holding means along the guiding means and toward the substrate, lining means disposed between the fastener guiding means and the fastener pushing means, wherein the lining means is composed of a material that is more prone to wear than the material of the pushing means such that in operation the lining means wears in preference to the guiding and or pushing means and actuating the fastener pushing means such that a fastener is inserted into the substrate.
